(19) United States
(12) Patent Application Publication
(10) Pub. No.: US 2021/0225599 A1
(43) Pub. Date: Jul. 22, 2021

(54) SYSTEM AND METHOD FOR PROVIDING INDICATION OF A POSITION OF A SWITCH

(71) Applicant: Hubbell Incorporated, Shelton, CT (US)

(72) Inventor: David Rhein, Birmingham, AL (US)

(21) Appl. No.: 17/154,460

(22) Filed: Jan. 21, 2021

Related U.S. Application Data
(60) Provisional application No. 62/963,696, filed on Jan. 21, 2020.

(51) Int. Cl. H01H 9/16; H01H 71/04

(52) U.S. Cl. CPC H01H 9/16; H01H 2071/046; H01H 71/04

(57) ABSTRACT

A switch including a blade, an electrical terminal, and a inclinometer sensor. The blade is pivotable between an open position and a closed position. The electrical terminal is configured to receive the blade when in the closed blade position. The inclinometer sensor is coupled to the blade. The inclinometer sensor is configured to sense a position of the blade and output a signal corresponding to the position.

### RELATED APPLICATIONS

The present application claims priority to U.S. Provisional Patent Application No. 62/963,696, filed Jan. 21, 2020, the entire contents of which are hereby incorporated.

### FIELD

Embodiments relate to electrical switches, and more particularly, high-voltage electrical switches.

### SUMMARY

When electrical switches, such as air break switches, are not placed in a fully closed position, electrical contacts of the electrical switch may have a high resistance that may lead to over-heating and even failure of the switch.

Thus, one embodiment provides a switch including a blade, an electrical terminal, and an inclinometer sensor. The blade is pivotable between an open position and a closed position. The electrical terminal is configured to receive the blade when in the closed blade position. The inclinometer sensor is coupled to the blade. The inclinometer sensor is configured to sense a position of the blade and output a signal corresponding to the position. In some embodiments, the inclinometer sensor is configured to sense the position of the blade with respect to a first plane and a second plane.

Another embodiment provides a system for collecting information related to an electrical switch. The system a first switch, a second switch, and a collector. The first switch includes a first blade, a first electrical terminal, and a first inclinometer sensor. The first blade is pivotable between an open position and a closed position. The first electrical terminal is configured to receive the first blade when in the closed blade position. The first inclinometer sensor is coupled to the first blade. The first inclinometer sensor is configured to sense a position of the first blade, and output a first signal corresponding to the position.

The second switch includes a second blade, a second electrical terminal, and a second inclinometer sensor. The second blade is pivotable between an open position and a closed position. The second electrical terminal is configured to receive the second blade when in the closed blade position. The second inclinometer sensor is coupled to the second blade. The second inclinometer sensor is configured to sense a position of the second blade, and output a second signal corresponding to the position. The collector is configured to receive the first signal from the first communications device and the second signal from the second communications device

Yet another embodiment provides a method of indicating position of a blade of a switch. The method includes sensing, via an inclinometer sensor, a position of the blade; outputting a signal indicative of the position of the blade; and receiving, via a collector, the signal indicative of the position of the blade.

Other aspects of the application will become apparent by consideration of the detailed description and accompanying drawings.

### BRIEF DESCRIPTION OF THE DRAWINGS

FIG. 1 is a perspective view of a substation according to some embodiments.

FIG. 2 is a front view of a switch of the substation of FIG. 1 according to some embodiments.

FIGS. 3A & 3B are side views of a terminal of a switch of the substation of FIG. 1 according to some embodiments.

FIG. 4 is a block diagram of a collector of the substation of FIG. 1 according to some embodiments.

FIG. 5 is a flowchart illustration an operation of the substation of FIG. 1 according to some embodiments.

FIG. 6 is a block diagram of a collection system according to some embodiments.

FIGS. 7A & 7B illustrates a sensor according to some embodiments.

FIG. 8 illustrates the sensor of FIGS. 7A & 7B secured to the switch of FIG. 2 according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

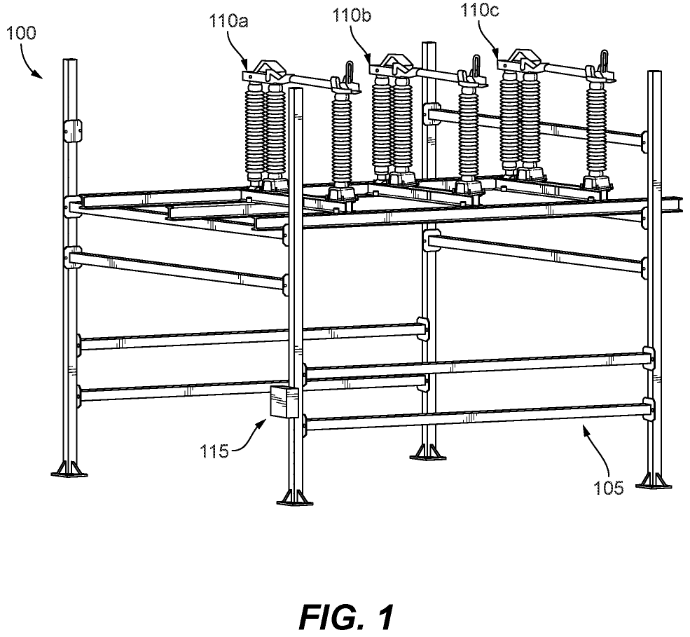

FIG. 1 is a perspective view of a substation 100 according to some embodiments. The substation 100 includes a base 105, one or more switches 110a-110c, and a collector 115. The base 105 is configured to support the switches 110. In some embodiments, the collector 115 is further supported by the base 105. In other embodiments, the collector 115 is located remotely from the base 105. The base 105 may be any type of appropriate utility structure, including but not limited, to a substation structure.

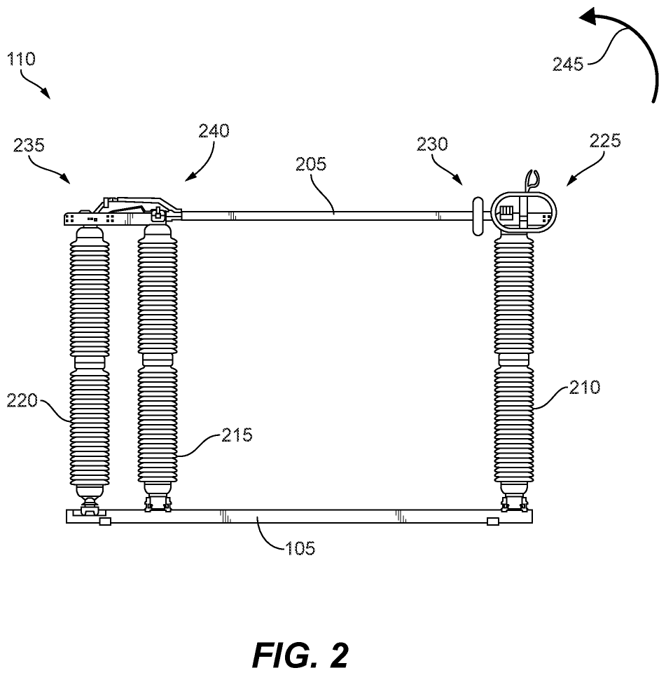

FIG. 2 illustrates a front view of a switch 110 according to some embodiments. Switch 110 may be a high voltage and/or high current switch configured to electrically connect/disconnect a power source to a load. In some embodiments, switch 110 is an air break switch. Although illustrated as a vertical break switch, in other embodiments, switch 110 may be a side break switch, a double end break switch, a center break switch, a hookstick switch, or any other switch style.

Switch 110 includes a blade 205 configured to move between a closed position (as illustrated in FIG. 2) and an open position. The switch 110 further includes a first insulator 210, a second insulator 215, and a third insulator 220, supported by the base 105.

The first insulator 210 supports an electrical terminal 225. The electrical terminal 225 is configured to receive a first end 230 of the blade 205. The second insulator 215 supports a hinge 235. The hinge 235 rotatably mounts the blade 205 at a second end 240 of the blade 205, opposite the first end 230.

In operation, when the blade 205 is in the closed position (as illustrated in FIG. 2), the power source is electrically connected to the load. When in the closed position, the blade 205 may be rotated, in a first direction 245, to the open position. When the blade 205 is in the open position, the power source is electrically disconnected from the load. In some embodiments, the first direction 245 moves along a first plane (for example, a pitch plane).

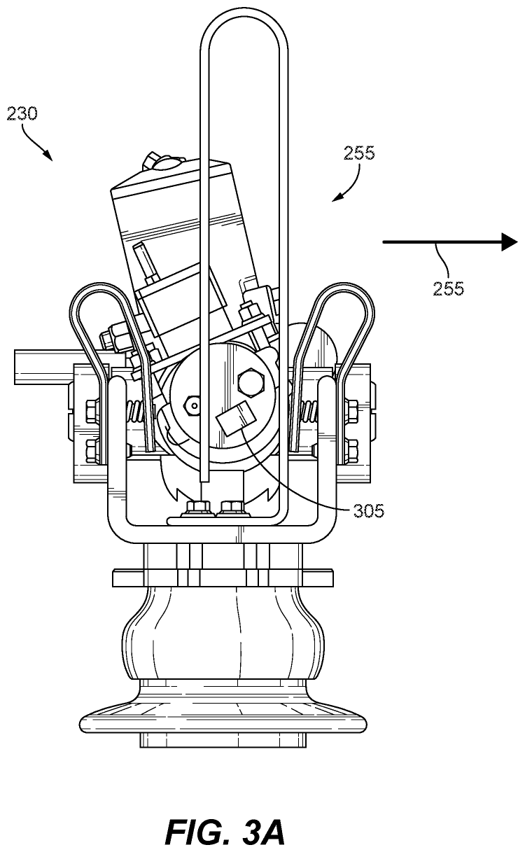

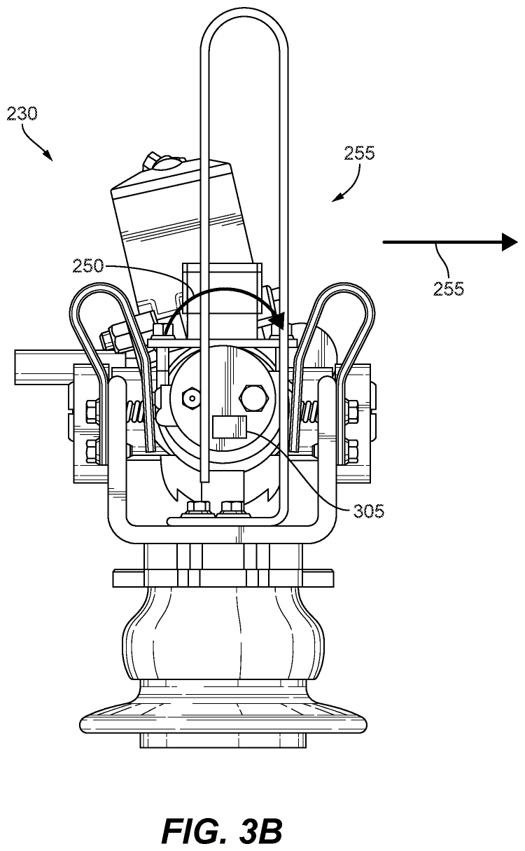

FIGS. 3A & 3B illustrate a front view of switch 110 according to some embodiments. In such an embodiment, when the blade 205 is in the closed position, the blade 205 may be further placed from an unlocked position (FIG. 3A) to a locked position (FIG. 3B). In some embodiments, the blade 205 is placed in the locked position by rotating the blade 205 in a second direction 250 along a second plane (for example, a roll plane).

As further illustrated in FIGS. 3A & 3B, switch 110 may further include a sensor 305. In some embodiments, sensor 305 is a inclinometer (or tilt) sensor, such as an accelerometer sensor configured to sense a three-dimensional orientation of the blade 205 along the first plane, the second plane, and a third plane (for example, a yaw plane). In some embodiments, the sensor 305 is a gyroscope and/or other types of inclinometer (or tilt)sensors configured to sense two or more direction of incline or tilt. For example, sensor 305 may be configured to sense when blade 205 is: (1) in a closed position or an open position; (2) in a locked position or an unlocked position; and/or (3) in a swing direction. In some embodiments, the swing direction may be represented by a third direction 255.

In some embodiments, the sensor 305 may be a combination of sensors. For example, the sensor 305 may be a combination including, but not limited to, one or more accelerometers, one or more gyroscopes, and one or more magnetometers. In such an embodiment, the sensor 305 may receive sensed information from the combination of sensors to determine when blade 205 is: (1) in the closed position or the open position; (2) in the locked position or he unlocked position; and/or (3) in the swing direction. For example, sensed information from the one or more magnetometer may be used to correct any errors in the sensed information from the one or more accelerometers and/or one or more gyroscopes that may be caused by the flow of current through switch 110.

In some embodiments, sensor 305 may be, or further include, a limit switch, a proximity sensor, a Hall effect sensor, a capacitive sensor, an optical sensor, an inductive sensor, a vibration sensor, and/or an ultrasonic sensor.

In some embodiments, sensor 305 may be, or further include, a temperature sensor. In such an embodiment, the sensor 305 is configured to sense a temperature of the terminal 225. In such an embodiment, the temperature sensor may be a thermocouple or similar temperature sensor. In some embodiments, the temperature sensor may be used to determine when the switch 110 is carrying current. In some embodiments, the sensor 305 is configured to determine if the switch 110 is overheating.

In yet other embodiments, the substation 100 includes one or more temperature sensors configured to sense one or more temperatures of the substation 100 at various locations external sensor 305. In such an embodiment, the one or more sensors may output temperature data to the communicator 310.

The communicator 310 is configured to receive a signal from the sensor 305 indicative of the position (for example, closed position or open position; locked or unlocked position; and/or swing position) of the blade 205. The communicator 310 is further configured to output a signal indicative of the position of the blade 205 to an external device. In some embodiments, the communicator 310 is coupled to the sensor 305 via a wired connection. In other embodiments, the communicator 310 is coupled to the sensor 305 via a wireless connection. In yet other embodiments, the communicator 310 and the sensor 305 form a single unit.

In some embodiments, the sensor 305 (including the communicator 310 in some embodiments) is located in, or coupled to, the interior of the blade 205. In other embodiments, the senor 305 (including the communicator 310 in some embodiments) is located on, or coupled to, the exterior of the blade 205.

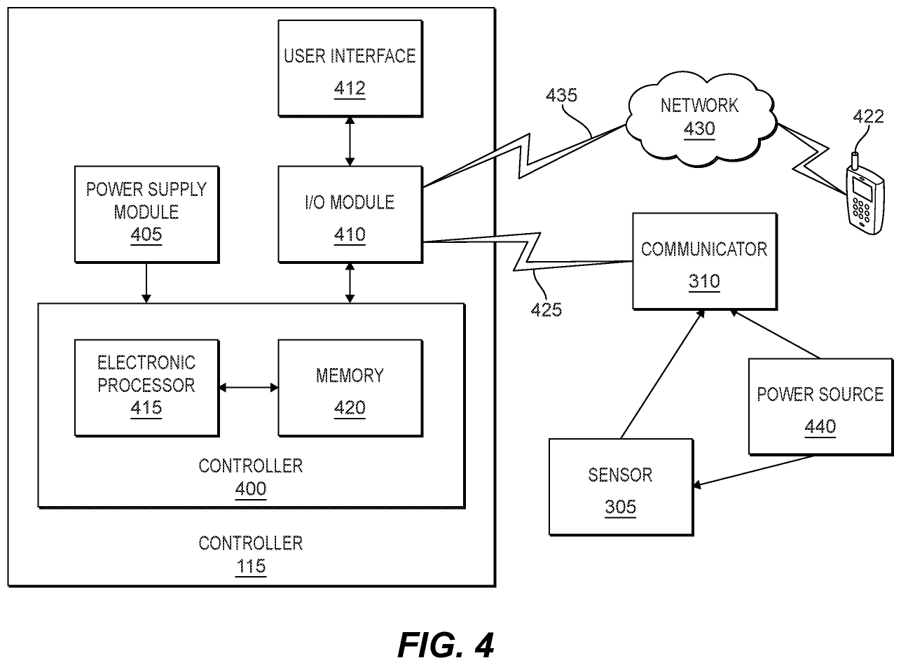

FIG. 4 is a block diagram of the collector 115 according to some embodiments. The collector 115 includes a controller 400 electrically and/or communicatively connected to a variety of modules or components of the collector 115. For example, the controller 400 may be connected to a power supply module 405, an input/output (I/O) module 410, and a user-interface 412.

In some embodiments, the controller 400 includes a plurality of electrical and electronic components that provide power, operational control, and protection to the components and modules within the controller 400 and/or the collector 115. For example, the controller 400 includes, among other things, an electronic processor 415 (for example, a microprocessor or another suitable programmable device) and the memory 420.

The memory 420 includes, for example, a program storage area and a data storage area. The program storage area and the data storage area can include combinations of different types of memory, such as read-only memory (ROM), random access memory (RAM). Various non-transitory computer readable media, for example, magnetic, optical, physical, or electronic memory may be used. The electronic processor 415 is communicatively coupled to the memory 420 and executes software instructions that are stored in the memory 420, or stored on another non-transitory computer readable medium such as another memory or a disc. The software may include one or more applications, program data, filters, rules, one or more program modules, and other executable instructions.

The power supply module 405 is configured to supply a nominal power to the controller 400 and/or other components/modules of the collector 115. In some embodiments, the power supply module 405 receives power from an external source. In other embodiments, the power supply module 405 may receive power from another power sources, such but not limited to, a battery and/or a renewable power source.

The I/O module 410 is configured to provide communication between collector 115 and one or more networks and/or devices (for example, communicator 310 and/or device 422). In the illustrated embodiment, the I/O module 410 provides communication with the communicator 310, via a first communication link 425, and provides communication with a network 430, via a second communication link 435. In some embodiments, the first communication link 425 is a wireless communication link (for example, a radio frequency (RF) communications link, a Bluetooth communications link, a WiFi communications link, etc.). In some embodiments, the first communication link 425 may be part of a local area network (LAN), a neighborhood area network (NAN), a home area network (HAN), or personal area network (PAN).

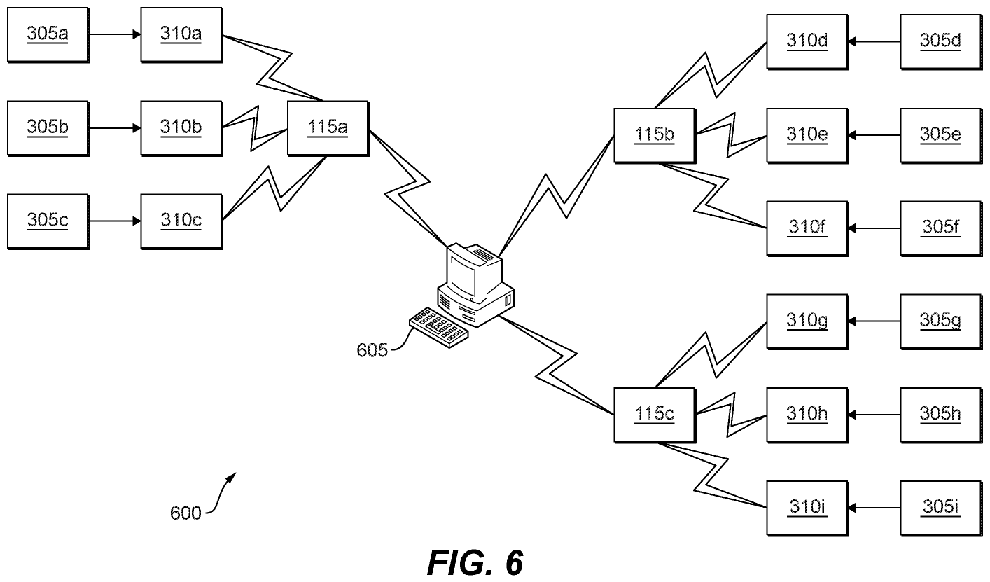

In some embodiments, the second communication link 435 may also be a wireless communication link (for example, a radio frequency (RF) communications link, a Bluetooth communications link, a WiFi communications link, etc.). In some embodiments, the collector 115 may communicate with the device 422 through the second communication link 435 and the network 430. The network 430 is, for example, a wide area network (WAN) (e.g., the Internet, a TCP/IP based network, a cellular network, such as, for example, a Global System for Mobile Communications [GSM] network, a General Packet Radio Service [GPRS] network, a Code Division Multiple Access [CDMA] network, an Evolution-Data Optimized [EV-DO] network, an Enhanced Data Rates for GSM Evolution [EDGE] network, a 3GSM network, a 4GSM network, a Digital Enhanced Cordless Telecommunications [DECT] network , a Digital AMPS [IS-136/TDMA] network, or an Integrated Digital Enhanced Network [iDEN] network, etc.). In other embodiments, the network is, for example, a local area network (LAN), a neighborhood area network (NAN), a home area network (HAN), or personal area network (PAN) employing any of a variety of communications protocols, such as Wi-Fi, Bluetooth, ZigBee, etc. In yet another embodiment, the network includes one or more of a wide area network (WAN), a local area network (LAN), a neighborhood area network (NAN), a home area network (HAN), or personal area network (PAN). The device 422 may be any external electronic device, for example, an external computer (for example, main computer 605 of FIG. 6), a server, a tablet, a smart phone, etc.

The user-interface 412 is configured to output information concerning the collector 115, switch 110 (for example, blade position), and/or the substation 100. The user-interface 412 may include a display (e.g., a primary display, a secondary display, etc.) and input devices such as touch-screen displays, a plurality of knobs, dials, switches, buttons, etc. The display is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc.

As illustrated in FIG. 4, the sensor 305 and/or the communicator 310 may be powered via a power source 440. In some embodiments, the power source 440 may be, or include, a battery. In some embodiments, the power source 440 may be, or include, a current transformer (CT). In such an embodiments, power may be inductively received and provided to the sensor 305 and/or communicator 310. In some embodiments, the power source 440 inductively receives power (for example, via CT) and charges a rechargeable battery via the power. The power may then be provided via the rechargeable battery.

In operation, sensor 305 senses the position (for example, open position and/or closed position; locked position and/or unlocked position; and/or swing position) of blade 205. The sensor 305 sends a first signal indicative of blade position to the communicator 310. The communicator 310, via the first communication link 425, sends a second signal indicative of blade position to collector 115. The collector 115 may then output the blade position using the user-interface 412 and/or output the blade position via the second communication link 435 and network 430.

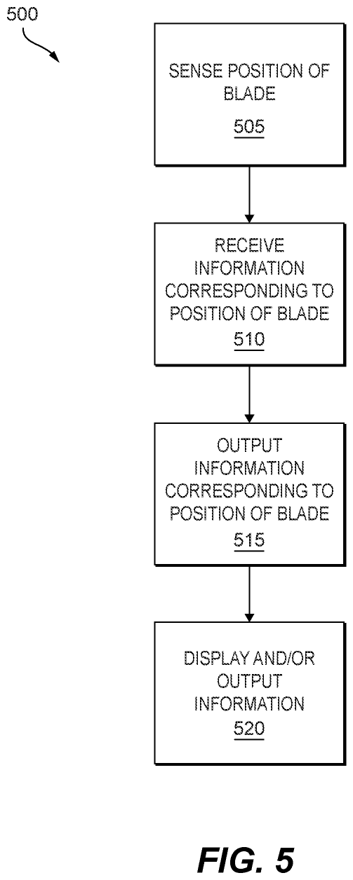

FIG. 5 illustrates a process, or operation, 500 according to some embodiments. It should be understood that the order of the steps disclosed in process 500 could vary. Furthermore, additional steps may be added to the process and not all of the steps may be required. Sensor 305 senses a position of blade 205 (block 505). Communicator 310 receives information corresponding to the position of blade 205 (block 510). Communicator 310 outputs a signal indicative of the position of blade 205 to the collector 115 (block 515). The collector 115 outputs information indicative of the position of the blade 205 (block 520). As discussed above, the collector 115 may output the information to user-interface 412 and/or a device 422. In some embodiments, process 500 may be repeated at predetermined time periods (for example, every lms, every 1 minute, etc.).

FIG. 6 illustrates a collection system 600 according to some embodiments. The collection system 600 includes a main computer 605, one or more sensors 305a-305i, one or more communicators 310a-310i, and one or more collectors 115a-115c. In some embodiments, the collection system 600 is a supervisory control and data acquisition (SCADA) system.

In operation, each collector 115 may correspond to a base 105. Each collector 115 may be configured to receive one or more signals indicative of blade position from one or more switches 110 (of a respective base 105) including sensors 305 and communicators 310. Each collector 115 is further configured to communicate the blade position of the one or more switches 110 to the main computer 605. The main computer 605 is configured to analyze and/or monitor the blade position of each switch 110 of each base 105. In some embodiments, the main computer 605 is further configured to output information and/or alerts related to the switches 110.

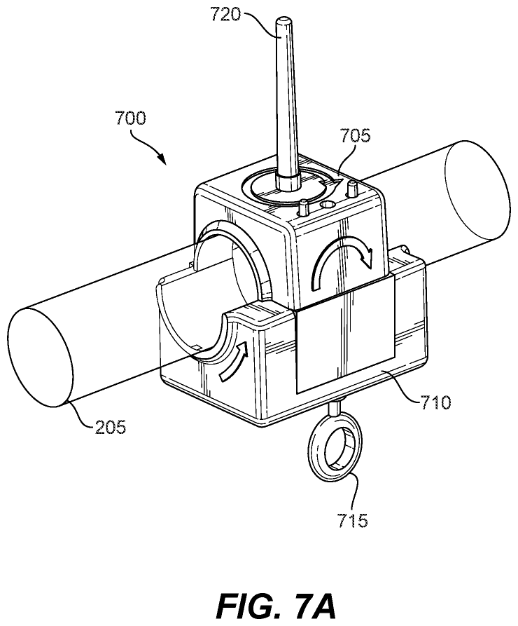

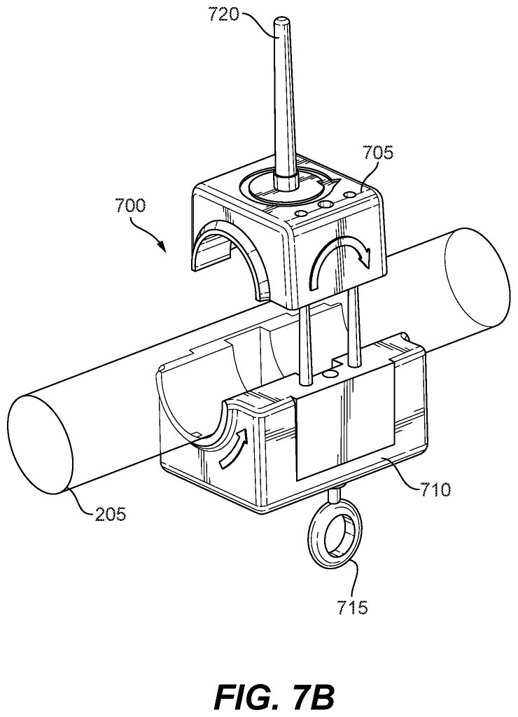

FIGS. 7A and 7B illustrates a sensor 700 according to some embodiments. The sensor 700 may be substantially similar to, or include, sensor 305. In some embodiments, the sensor 700 includes the sensor 305 and the communicator 310. In some embodiments, the sensor includes the sensor 305, the communicator 310, and the power source 440. In some embodiments, the sensor includes the sensor 305, the communicator 310, the power source 440, and other electrical components (for example, additional sensors as discussed above with respect to sensor 305).

As illustrated, in some embodiments, the sensor 700 includes a top housing 705 and a bottom housing 710. The sensor 700, via the top housing 705 and the bottom housing 710, may be configured to couple to an exterior of the blade 205. In exemplary operation, the top housing 705 is separated from the bottom housing 710 (FIG. 7B) and the housing are placed around the blade 205. The blade 205 is then enclosed within the top housing 705 and the bottom housing 710 (FIG. 7A). In some embodiments, the top housing 705 may be secured to the bottom housing 710. For example, by a user rotating a lock, or user-interface 715.

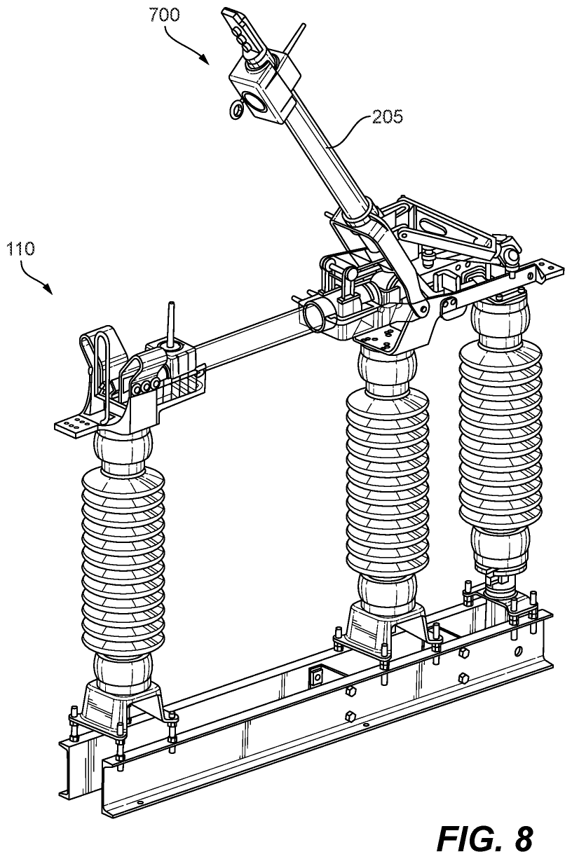

In some embodiments, the sensor 700 further includes an antenna 720. The antenna 720 may be communicatively coupled to (or part of) the communicator 310. In such an embodiments, the antenna 720 may aid in providing the first communication link 425. FIG. 8 illustrates the sensor 700 secured to the blade 205 of the switch 110.

Thus, the application provides, among other things, a system and method for indicating a blade position of one or more switches. Various features and advantages of the application are set forth in the following claims.

What is claimed is:

1. A switch comprising:
a blade pivotable between an open position and a closed position;
an electrical terminal configured to receive the blade when in the closed blade position;
a inclinometer sensor coupled to the blade, the inclinometer sensor configured to sense a position of the blade, and
output a signal corresponding to the position.

2. The switch of claim 1, wherein the inclinometer sensor includes at least one selected from a group consisting of an accelerometer, a gyroscope, and a magnetometer.

3. The switch of claim 1, further comprising a communication device communicatively coupled to the sensor.

4. The switch of claim 3, wherein the communication device is configured to receive the signal and output a second signal to a collector device.

5. The switch of claim 4, wherein the communication device is a radio frequency communication device.

6. The switch of claim 4, wherein the collector device is configured to display information indicative of the position.

7. The switch of claim 4, wherein the collector device is configured to output information indicative of the position to an external computer.

8. The switch of claim 1, wherein the inclinometer sensor is further configured to sense a first orientation of the blade along a first plane.

9. The switch of claim 8, wherein the first plane corresponds to a roll angle of the blade.

10. The switch of claim 8, wherein the inclinometer sensor is further configured to sense a second orientation of the blade along a second plane.

11. The switch of claim 10, wherein the second plane corresponds to a pitch angle of the blade.

12. The switch of claim 10, wherein the inclinometer sensor is further configured to sense a third orientation of the blade along a third plane.

13. The switch of claim 12, wherein the second plane corresponds to a yaw angle of the blade.

14. The switch of claim 12, further comprising a temperature sensor.

15. The switch of claim 14, wherein the temperature sensor is configured to determine when the switch is carrying current.

16. The switch of claim 1, wherein the inclinometer sensor is configured to sense the position of the blade with respect to a first plane and a second plane.

17. The switch of claim 16, wherein the inclinometer sensor is further configured to sense the position of the blade with respect to a third plane.

18. A system for collecting information related to an electrical switch, the system comprising:
a first switch including
a first blade pivotable between an open position and a closed position,
a first electrical terminal configured to receive the first blade when in the closed blade position,
a first inclinometer sensor coupled to the first blade, the first inclinometer sensor configured to
sense a position of the first blade, and
output a first signal corresponding to the position;
a second switch including
a second blade pivotable between an open position and a closed position,
a second electrical terminal configured to receive the second blade when in the closed blade position,
a second inclinometer sensor coupled to the second blade, the second inclinometer sensor configured to
sense a position of the second electrical terminal blade, and
output a second electrical terminal signal corresponding to the position; and
a collector configured to receive the first signal from the first communications device and the second signal from the second communications device.

19. The system of claim 18, wherein the first and second inclinometer sensors are at least one selected from a group consisting of accelerometers and gyroscopes.

20. The system of claim 18, wherein the first switch further includes a first communicator and the second switch further includes a second communicator.

21. The system of claim 20, wherein first and second communicators output the first and second signals to the collector.

22. The system of claim 19 further comprising one or more temperature sensors configured to sense one or more temperatures at one or more locations.

23. A method of indicating position of a blade of a switch, the method comprising:
sensing, via a inclinometer sensor, a position of the blade;
outputting a signal indicative of the position of the blade; and
receiving, via a collector, the signal indicative of the position of the blade.

24. The method of claim 23, wherein the inclinometer sensor includes at least one selected from a group consisting of an accelerometer, a gyroscope, and a magnetometer.

25. The method of claim 23, wherein the collector is position remotely from the sensor.

26. The method of claim 23, further comprising displaying information indicative of the position of the blade.

27. The method of claim 23, further comprising
sensing, via a second inclinometer sensor, a position of a second blade;
outputting a second signal indicative of the position of the second blade; and
receiving, via the collector, the second signal indicative of the position of the second blade.

28. The method of claim 23, further comprising:
sensing, via a temperature sensor, a temperature of the switch; and
receiving, via the collector, a signal indicative of the temperature of the switch.
